(19) United States
(12) Patent Application Publication
(10) Pub. No.: US 2017/0351156 A1
(43) Pub. Date: Dec. 7, 2017

(54) Optical Device and Optical Device Manufacturing Method

(71) Applicant: Hitachi, Ltd., Chiyoda-ku, Tokyo (JP)

(72) Inventors: Ryo IMAI, Tokyo (JP); Hiroyuki MINEMURA, Tokyo (JP)

(21) Appl. No.: 15/538,020

(22) PCT Filed: May 29, 2015
(86) PCT No.: PCT/JP2015/065516

§ 371 Date: Jun. 20, 2017

(51) Int. Cl. G02F 1/35; G02B 5/18; B23K 26/55; B23K 26/00; G02B 6/13; B23K 26/06; B23K 103/00

(52) U.S. Cl. CPC G02F 1/3523; G02B 6/13; G02B 5/1857; B23K 26/0608; B23K 26/55; B23K 26/0006; B23K 26/006; B23K 2203/54

(57) ABSTRACT

An object of the present invention is to provide a technique capable of easily manufacturing a desired optical device at the inside of a transparent board. An optical device according to the present invention is manufactured by denaturing the vicinity of a hollow structure at the inside of the transparent board and deforming the shape of the hollow structure

### TECHNICAL FIELD

The present invention relates to an optical device.

### BACKGROUND ART

When configuring a system with an optical function, in many cases, a so-called spatial optical system in which optical devices having various optical functions are disposed, and in which light is controlled to be propagated through a space by these optical devices, is adopted as a form. On the other hand, in recent years, a technique for realizing a system with an optical function by forming various optical devices at the inside of a transparent board is studied.

As a method for forming an optical device at the inside of a transparent board, a change in the refractive index of a transparent material due to a nonlinear optical effect can be used. When a transparent board is irradiated with a short pulse laser, the chemical/physical structure of the transparent board is changed at a focal point of the laser beam, and the refractive index of the material is changed. This phenomenon is caused by the nonlinear optical effect, and the refractive index of the board is changed only at the focal point. Therefore, since the optical device can be disposed at an arbitrary position at the inside of the board and a three-dimensional optical system can be formed, and thus the size of the optical system can be reduced. Further, since the devices are integrated into the inside of one board, there is also an advantage in that the optical system is stable against disturbance such as vibration and contamination.

As techniques for realizing an optical function by forming a cavity at the inside of a transparent medium, there are the following PTL 1 to PTL 3.

### CITATION LIST

### Patent Literature

PTL 1: US 2009122407 A1

PTL 2: JP-A-2007-034004

PTL 3: JP-A-2003-131053

### SUMMARY OF INVENTION

### Technical Problem

In the case of forming an optical device using a change in the refractive index by irradiation of a short pulse laser, there is a problem in that an amount of change in the refractive index is small. For example, in the case of a quartz glass which is often used as a material of an optical device, an amount of change in the refractive index by irradiation of a short pulse laser largely depends on a light irradiation condition, but is less than approximately 1%. For this reason, it is difficult to manufacture devices such as some optical devices used in a spatial optical system, specifically, lenses, which cause an optical function by a light refraction effect at an interface.

On the other hand, as a method for realizing an optical function using a small amount of change in the refractive index, there is a method using diffraction by a periodic structure. For example, the function of a lens can be realized by forming a concentric circular structure. However, in this method, it takes some time to form a concentric circular structure by laser processing. In addition, in order to obtain diffraction efficiency suitable for a practical use, a measure such as formation of a multilayer structure is required, and thus the time required for forming a device becomes further longer. Further, when a simple concentric circular structure is adopted, chromatic aberration increases because the focal length is inversely proportional to the wavelength.

It is also considered that an optical device is manufactured by forming an interface using etching of a transparent board such as a glass. In this case, the problem in that a difference in the refractive index is small in laser processing is solved. However, there is a restriction in which the interface should be formed from the outer surface of the board. In addition, processing for smoothing the etched surface is necessary.

In the technique described in PTL 1, an optical function is realized by sequentially disposing fine cavity structures having a substantially spherical shape. Thus, since the technique assumes that a plurality of cavity structures are formed at the inside of a transparent medium, the corresponding processing time is required according to the number of the cavity structures.

In the technique described in PTL 2, an optical function is realized by irregularly forming a plurality of flat cavities 5 at the inside of a denaturation region 4 (refer to abstract). Thus, the optical function depends on disposition of the denaturation region 4 and the number of the cavities 5, and it is considered that the processing process becomes complicated or a corresponding processing time is necessary.

In PTL 3, a bubble (cavity) is formed at an inflection point of a waveguide, and the bubble is used as a reflection mirror. In this configuration, since a contact point between the bubble and the waveguide is important, the shape of the bubble is assumed to be a flat plate shape. Thus, it is not clearly mentioned that various optical functions are imparted by controlling the shape of the cavity.

The present invention has been made in consideration of the problems, and an object of the present invention is to provide a technique capable of easily manufacturing a desired optical device at the inside of a transparent board.

### Solution to Problem

An optical device according to the present invention is manufactured by denaturing the vicinity of a hollow structure at the inside of a transparent board and deforming the shape of the hollow structure.

### Advantageous Effects of Invention

According to the present invention, it is possible to easily manufacture an optical device at the inside of a transparent board in a short time. The objects, configurations, and effects other than those described above will be clarified from the description of the following embodiments.

### BRIEF DESCRIPTION OF DRAWINGS

FIG. 1 is a diagram for explaining a difference in the types of optical systems.

FIG. 2 is a conceptual diagram for explaining an optical device according to a first embodiment and a manufacturing method of the optical device.

FIG. 3 is a diagram illustrating a configuration example of an optical device manufacturing apparatus 100 according to the first embodiment.

FIG. 4 is a timing chart for explaining the operation of the optical device manufacturing apparatus 100.

FIG. 5 illustrates microscope photographs of a hollow structure 21, and a titanium sapphire laser is used as a short pulse laser.

FIG. 6 is a microscope photograph in a case where the irradiation position of LASER2 is closer to the irradiation position of LASER1 compared to the case of FIG. 5.

FIG. 7 is a diagram illustrating another configuration example of an optical device manufacturing apparatus 100 according to a second embodiment.

FIG. 8 is a timing chart for explaining the operation of the optical device manufacturing apparatus 100 according to the second embodiment.

FIG. 9 is a flow chart explaining a procedure for manufacturing an optical device according to the second embodiment.

FIG. 10 is a diagram illustrating an example of the shape of the hollow structure 21 formed by the optical device manufacturing method according to the first and second embodiments.

FIG. 11 is a diagram illustrating the optical response of the hollow structure 21 illustrated in FIG. 10(a).

FIG. 12 is a diagram illustrating the optical response of the hollow structure 21 illustrated in FIG. 10(b).

FIG. 13 is a diagram illustrating an example in which a concave minor is formed by the hollow structure 21.

FIG. 14 is a diagram illustrating a configuration example of an optical system using the optical device illustrated in FIG. 10(b).

### DESCRIPTION OF EMBODIMENTS

### Optical Device In Related Art

In the following, in order to facilitate understanding of the present invention, first, an optical device in the related art and a manufacturing method thereof will be described, and thereafter an optical device according to the present invention and a manufacturing method thereof will be described.

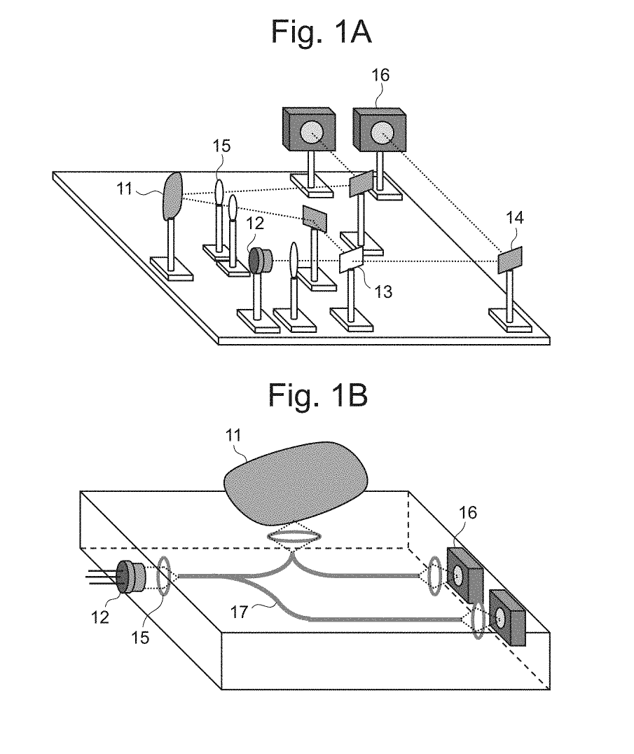

FIG. 1 is a diagram for explaining a difference in the types of optical systems. FIG. 1(a) illustrates a configuration example of a spatial optical system, and FIG. 1(b) illustrates an example of an optical system formed at the inside of a transparent board. In a spatial optical system, in many cases, an optical device is implemented by fixing the optical device to a base using a fixing tool. In a process in which light emitted from a light source 12 is propagated through air and is reached to a measurement object 11, the light is controlled by a beam splitter 13, a mirror 14, a lens 15, and the like, and is detected by a detector 16. On the other hand, in an optical system formed at the inside of a transparent board, an optical device is integrated into the inside of the transparent board, and light is propagated through a waveguide 17 formed at the inside of the board.

Specific examples of forming an optical device at the inside of a transparent board include the following examples: (a) an example for manufacturing a waveguide by providing a denaturation region in a linear shape; (b) an example of forming a diffraction type lens by forming a concentric circular structure; (c) an example of forming, at the inside of a transparent board, an interface between the transparent board and air, for example, forming a mirror by etching photosensitive glass, and using the refraction/reflection of light at the interface; and (d) an example of manufacturing a device for measuring the refractive index of a liquid by combining a bragg grating and a micro flow path.

In a method of forming a plurality of cavities at the inside of a transparent board and a method of forming an interface by etching, there are problems as described above. Thus, the present invention imparts a desired optical function to a cavity formed at the inside of the transparent board by changing the shape of the cavity.

### First Embodiment

In an optical device manufacturing method according to a first embodiment of the present invention, (a) a hollow structure is formed at the inside of a transparent board by a short pulse laser with a pulse width of 1 ns or less, and (b) the interface shape of the hollow structure is deformed according to a spatial pattern by a separate laser for controlling the interface shape of the hollow structure. Thus, an optical device with a hollow structure having an arbitrary shape is manufactured. It is known that a hollow structure is produced by irradiating a transparent material such as a quartz glass with a high repetition-rate pulse laser having a repetition-rate frequency exceeding 1 MHz. The hollow structure formed by the above-mentioned method has a spherical shape when an irradiation condition is adjusted.

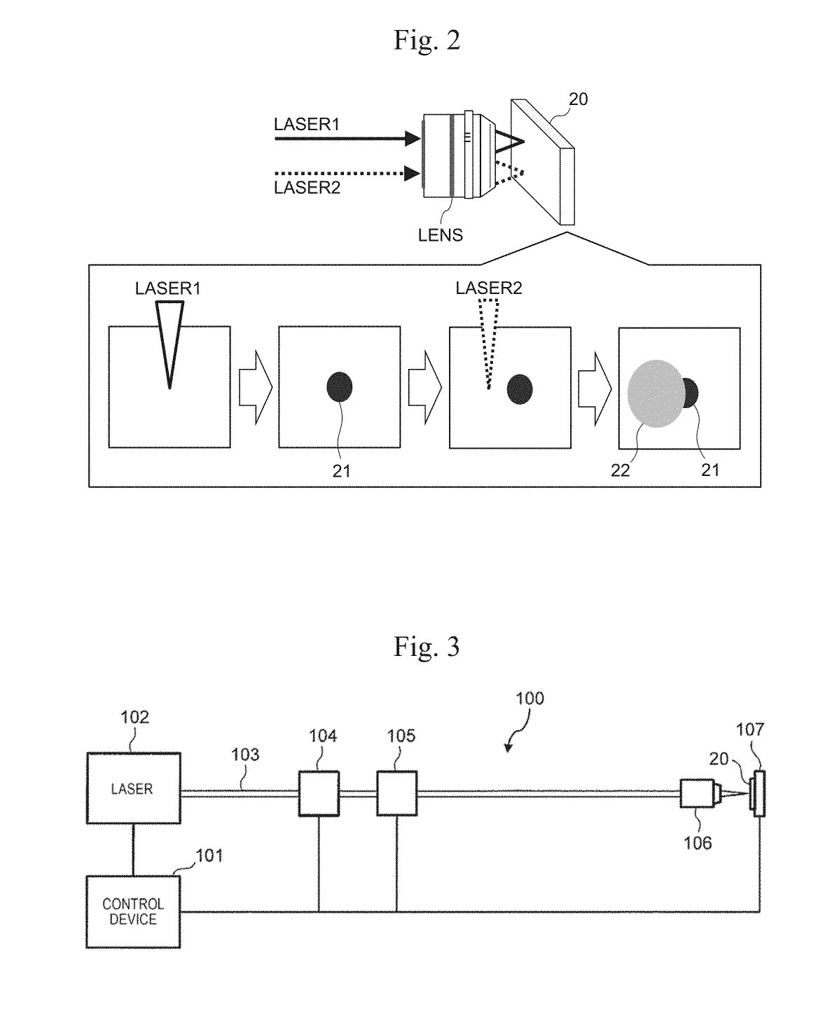

FIG. 2 is a conceptual diagram for explaining an optical device according to the first embodiment and a manufacturing method thereof. LASER1 is a laser beam for forming a hollow structure at the inside of a transparent board 20. LASER2 is a laser beam for denaturing the physical properties of the inside of the transparent board 20. An object lens LENS is disposed so as to condense the laser beams into the inside of the transparent board 20.

First, a hollow structure 21 is formed at the inside of the transparent board 20 by the LASER1. Next, a denaturation region 22 is formed at a position at the inside of the transparent board 20 that is different from the position of the hollow structure 21, by the LASER2. The hollow structure 21 is pressed by the denaturation region 22, and is deformed. Here, the denaturation region means a region where the chemical/physical properties of the transparent board 20 are changed by irradiation of the LASER2. Although the type of the change depends on the type of the material of the transparent board 20 and the irradiation condition of the laser beam, for example, the denaturation region is a region where the material is once dissolved. Preferably, the denaturation region does not remain after the laser irradiation. However, in a case where the optical influence of the denaturation region is small, the denaturation region may remain. The hollow structure, which has initially a spherical shape, is deformed by irradiation of the LASER2, and is shaped into a desired shape.

In FIG. 2, although the LASER1 and the LASER2 are illustrated to be separated, the LASER2 may be a laser beam branched from the LASER1. In addition, the LASER2 is not necessarily separated from the LASER1, and in a case where irradiation of the same laser beam is performed at different timings, a laser beam in one initial irradiation may be used as the LASER1 and a laser beam in the rest irradiation may be used as the LASER2. The irradiation of the LASER2 may be performed at approximately the same time as the irradiation of the LASER1, or the irradiation of the LASER2 may be performed after the irradiation of the LASER1. it is not necessary to control the shape of the hollow structure by one laser irradiation, and the shape of the hollow structure may be controlled in stages by irradiation of the LASER2 in multiple times. The shape of the hollow structure may be controlled by changing the spatial pattern of the LASER2 by a spatial light modulator or the like, for example, by a plurality of light spots.

In a manufacturing method of the optical device according to the first embodiment, three-dimensional processing by a nonlinear optical effect is used. Therefore, linear absorption of the laser beam by the transparent board 20 should be sufficiently small. At the wavelength of the laser beam forming the hollow structure, the absorption coefficient of the material of the transparent board 20 is equal to or less than 1 cm⁻¹.

The optical device using the hollow structure 21 according to the first embodiment functions basically by reflection or refraction of the light at the interface between the transparent board 20 and the hollow portion. In particular, the optical device functions as an optical device that changes a spatial pattern such as a light propagation direction and a light intensity distribution by using the phenomenon. Therefore, the function of the device is determined by the interface shape of the hollow structure 21. As particularly important shapes, there are a shape having a spherical surface and a shape having a substantially flat surface (realized as a spherical surface having a very large radius of curvature). The spherical shape functions as a lens for the refracted/reflected light. The shape of the optical device is not limited to a shape having only one spherical surface or one substantially flat surface. For example, the shape of the optical device may be a shape in which one or more spherical surfaces are combined with one or more substantially flat surfaces, or may be an arbitrary shape realized as a set of substantially flat surfaces.

FIG. 3 is a diagram illustrating a configuration example of an optical device manufacturing apparatus 100 according to the first embodiment. Here, an example configuration in which the LASER1 and the LASER2 are the same beam is illustrated. The optical device manufacturing apparatus 100 includes an optical processing system (102 to 106) and a control device 101. A short pulse laser 102 emits a laser beam 103. An optical shutter 104 adjusts the irradiation time of the laser beam 103. An attenuator 105 adjusts the power of the laser beam 103. An objective lens 106 condenses the laser beam 103 into the inside of the transparent board 20. An automatic stage 107 controls the position of the transparent board 20.

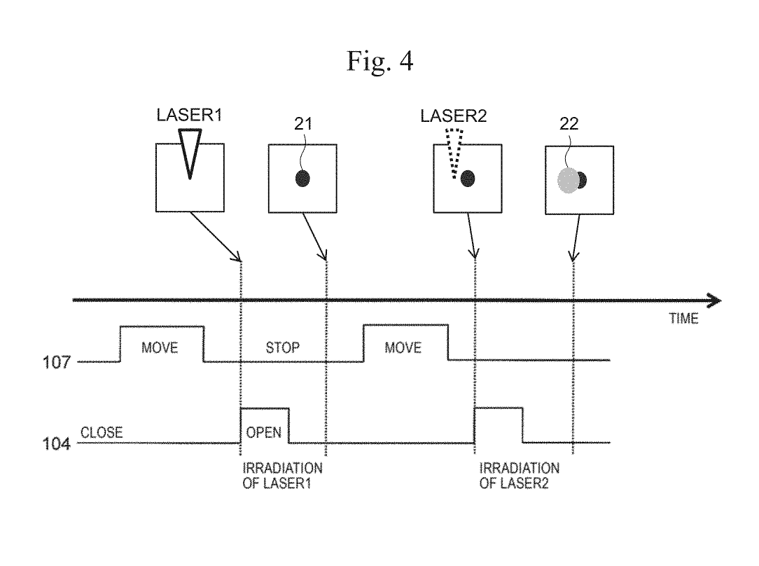

FIG. 4 is a timing chart for explaining the operation of the optical device manufacturing apparatus 100. The automatic stage 107 moves the transparent board 20 such that a position where the hollow structure 21 will be formed is irradiated with the LASER1. Next, the optical shutter 104 is opened, and irradiation of the LASER1 is performed. Thus, the hollow structure 21 is formed. Next, the automatic stage 107 moves the position of the transparent board 20. At this time, the attenuation rate of the optical power of the attenuator 105 may be simultaneously changed. After the position of the transparent board 20 is moved, the optical shutter 104 is opened again, and irradiation of the LASER2 is performed. The denaturation region 22 is formed and the shape of the hollow structure 21 is changed, by the LASER2.

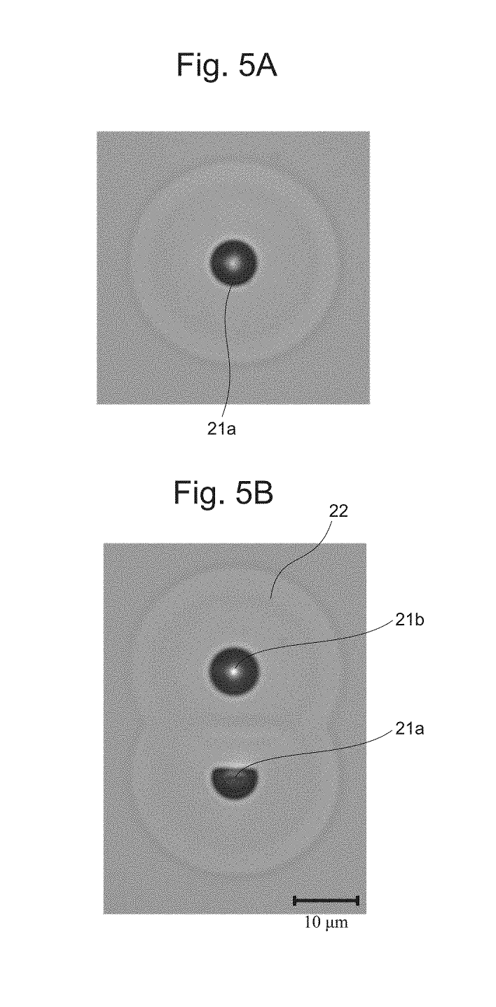

FIG. 5 illustrates microscope photographs of the hollow structure 21. As a short pulse laser, a titanium sapphire laser is used. The pulse energy of the emitted laser beam is 24 nJ, and the repetition-rate frequency of the pulse is 76 MHz. As the transparent board 20, a quartz glass is used. In the example illustrated in FIG. 5, a hollow structure 21a is formed by keeping the attenuation rate of the attenuator 105 constant, and by irradiating the transparent board 20 twice with laser beams having the same power, as the LASER1 and the LASER2, respectively. Then, the shape of the hollow structure 21a is controlled by the denaturation region 22. The irradiation time for both the LASER1 and the LASER2 is 100 ms.

FIG. 5(a) illustrates a state where the hollow structure 21a is formed by irradiation of the LASER1. FIG. 5(b) illustrates a state where the shape of the hollow structure 21a is controlled by the LASER2 after the hollow structure 21a is formed. As apparent from FIG. 5, the hollow structure 21a, which has a spherical shape in a state where the shape thereof is not controlled, is shaped into a hemispherical shape by the denaturation region 22 formed by irradiation of the LASER2. In the case of the irradiation conditions as described above, it is said that the denaturation region 22 is a region where heat is accumulated at the inside of the transparent board 20 by the laser irradiation and thus the board medium material is dissolved.

In the example illustrated in FIG. 5, since the irradiation condition of the LASER1 is the same as that of the LASER2, a hollow structure 21b is formed by irradiation of the LASER2. When the hollow structure 21a is used as an optical device, the hollow structure 21b may interfere with the hollow structure 21a in some cases. In such a case, it is possible to eliminate the hollow structure 21b by an extension of the present invention.

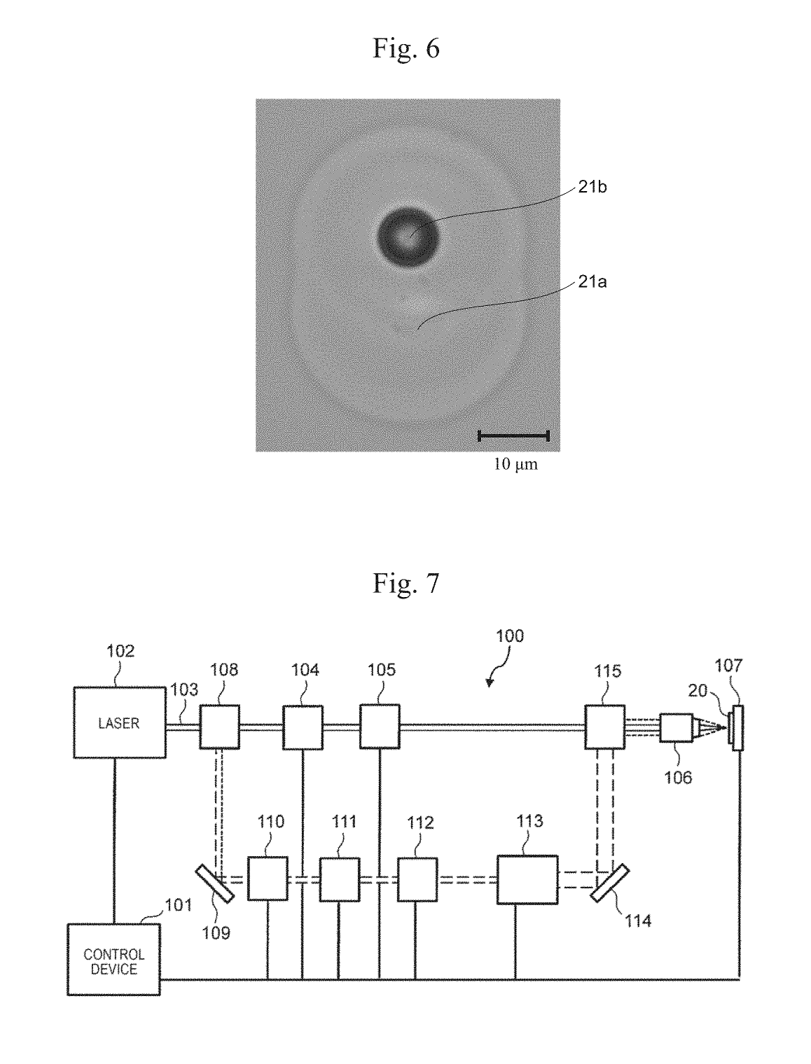

FIG. 6 is a microscope photograph in a case where the irradiation position of the LASER2 is closer to the irradiation position of the LASER1 compared to the case of FIG. 5. In FIG. 6, it is understood that the hollow structure 21a formed by the LASER1 is completely disappeared. According to this method, the hollow structure is transferred to a different position by sequentially eliminating unnecessary hollow structures, and thus it is possible to dispose the hollow structure at a position which does not hinder other optical functions.

In the example illustrated in FIG. 5, it is understood that the denaturation region 22 which is produced by dissolution of the board material due to the LASER2 remains. The refractive index of the denaturation region 22 is slightly changed compared to the refractive index of a non-processing region, but the amount of the change is small. Thus, the influence of the refractive index of the denaturation region 22 on the optical response is small. In a case where, even though the change of the refractive index of the denaturation region 22 is small, the influence of the refractive index of the denaturation region 22 on the optical response becomes a problem, the influence due to the interface of the denaturation region 22 on the optical response can be relaxed, by guiding the light to the inside of the denaturation region 22 using the waveguide.

In the examples described in FIGS. 5 and 6, although the hollow structure 21b is produced when the denaturation region 22 is produced, only the denaturation region 22 may be produced by adjusting parameters of the LASER2 such that the hollow structure 21b is not produced and performing irradiation of the LASER2.

Hereinafter, an advantage of the optical device manufacturing method described in the first embodiment will be described. In the case of forming a three-dimensional optical system at the inside of the transparent board 20, preferably, the periphery of the formed optical device remains unchanged so as not to influence other optical devices. When forming a cavity by a femtosecond laser, since a nonlinear absorption effect of light is used, in a place other than the vicinity of the focus of light, there is no change. Therefore, compared to a method of cutting the transparent board 20 from the outside by using etching or the like, the other places of the transparent board 20 are unlikely to be influenced. Further, since the nonlinear absorption effect is used, an optical device can be formed at an arbitrary position at the inside of the transparent board 20.

An example of forming a lens as an optical device is considered. In order to form a Fresnel lens using a change in the refractive index by laser irradiation, it is necessary to scan the laser spot many times in a concentric circular shape. On the other hand, in the optical device manufacturing method according to the first embodiment, an optical device is completely formed by several times of laser irradiation for forming the hollow structure 21 and controlling the shape of the hollow structure 21. Therefore, it is possible to manufacture an optical device in a short time.

### Second Embodiment

FIG. 7 is a diagram illustrating another configuration example of an optical device manufacturing apparatus 100 according to a second embodiment of the present invention. in the present configuration example, the degree of freedom in control is increased as compared with the configuration example illustrated in FIG. 3, by individually controlling the LASER1 and the LASER2.

A short pulse laser 102 emits a laser beam 103. An optical branch device 108 branches the laser beam 103 into a laser beam (LASER1) indicated by a solid line and a laser beam (LASER2) indicated by a broken line. Here, although the LASER1 and the LASER2 are generated by branching a single laser beam, laser beams emitted from two different lasers may be used. After the laser beam 103 is branched by the optical branch device 108, an optical shutter 104 adjusts the irradiation time of the LASER1. An attenuator 105 adjusts the power of the LASER1. A mirror 109 reflects the LASER2. An optical shutter 110 adjusts the irradiation time of the An attenuator 111 adjusts the power of the LASER2. An irradiation timing control device 112 controls the irradiation timing compared with the pulse of the LASER2. The adjustment of the irradiation timing of the LASER2 may be performed by the optical shutter 110. However, when there is a small difference between the irradiation timing of the LASER1 and the irradiation timing of the LASER2, preferably, for example, a delay line for adjusting the optical distance is used as the irradiation timing control device 112. A spatial pattern control device 113 modulates the LASER2 such that a desired optical pattern is formed on the transparent board 20. As the spatial pattern control device 113, for example, a spatial light modulator may be used. A mirror 114 reflects the LASER2. A multiplexer 115 multiplexes the LASER1 and the LASER2 (adjusts the irradiation position on the same axis) such that the LASER1 and the LASER2 travel in the same direction. An objective lens 106 condenses the multiplexed laser beams into the inside of the transparent board 20.

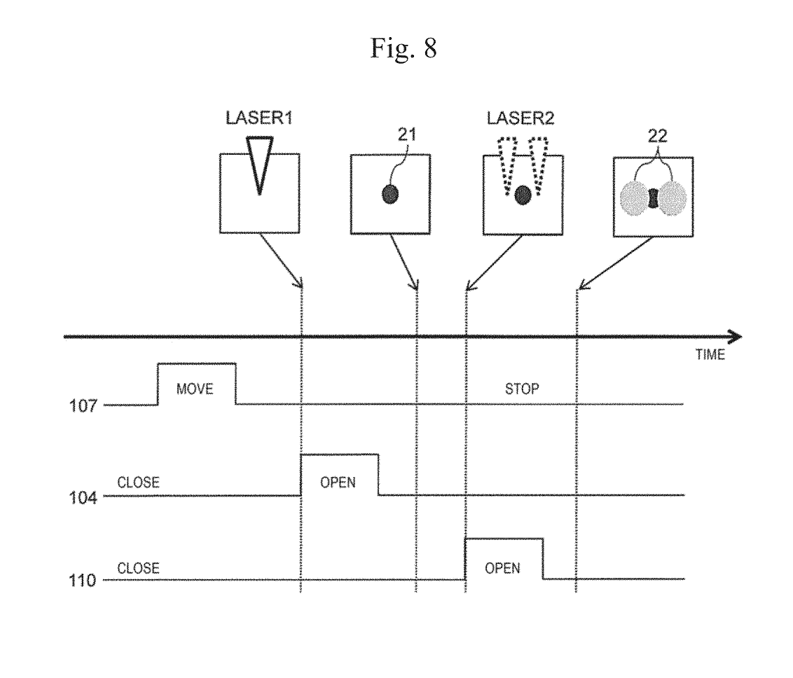

FIG. 8 is a timing chart for explaining the operation of the optical device manufacturing apparatus 100 according to the second embodiment. An automatic stage 107 disposes the transparent board 20 such that a position where the hollow structure 21 will be formed is irradiated with the LASER1. Next, the optical shutter 104 is opened, and irradiation of the LASER1 is performed. Thus, the hollow structure 21 is formed. Next, the optical shutter 110 is opened, and irradiation of the LASER2 is performed. In FIG. 8, although irradiation of the LASER2 is performed after irradiation of the LASER1 is performed, irradiation of these two laser beams may be performed at the same time (at approximately the same time). The beam shape of the LASER2 is shaped by the spatial pattern control device 113, and a denaturation region 22 according to the shape is formed. The shape of the hollow structure 21 is changed by the denaturation region 22. In FIG. 8, although irradiation of the LASER2 is performed only once, a plurality of denaturation regions 22 may be formed by performing irradiation of the LASER2 a plurality of times while changing the spatial pattern of the LASER 2.

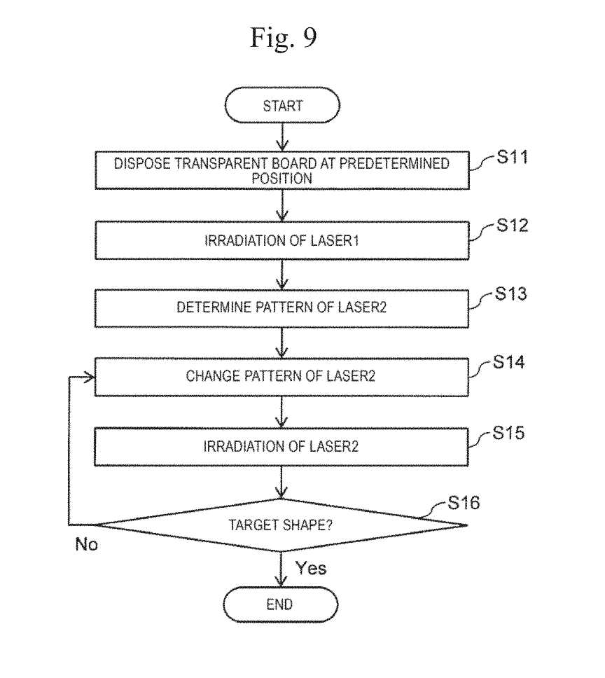

FIG. 9 is a flow chart explaining a procedure for manufacturing an optical device according to the second embodiment. First, the transparent board 20 is moved and disposed such that the laser beam is focused on a position where the optical device will be formed (S11). Next, the hollow structure 21 is formed at the inside of the transparent board 20 by performing irradiation of the LASER1 (S12). Next, a spatial pattern of the LASER2 is determined according to the shape of the hollow structure 21 to be finally formed (S13). In a case where irradiation of the LASER2 is performed a plurality of times, the order of irradiation is also determined in S13. Next, the spatial pattern for irradiation of the LASER2 is input to the spatial pattern control device 113 (S14). Thereafter, the optical shutter 110 is opened, and irradiation of the LASER2 is performed (S15). In a case where the shape of the hollow structure 21 becomes the target shape by the irradiation, the procedure is terminated, and in a case where the shape of the hollow structure 21 does not reach the target shape, the steps S14 to S15 are repeated (S16).

### Third Embodiment

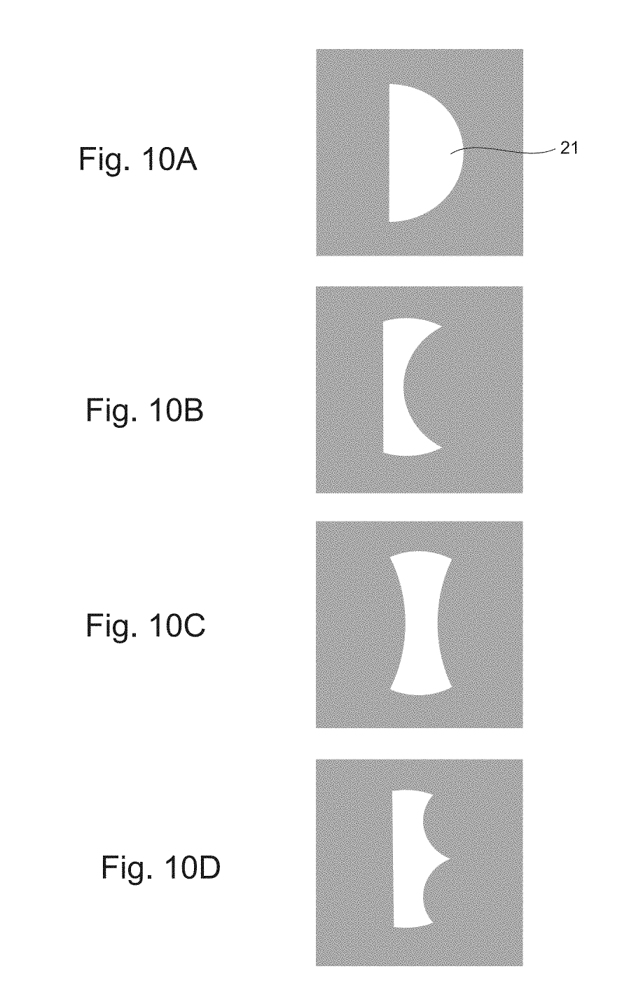

FIG. 10 is a diagram illustrating an example of the shape of the hollow structure 21 formed by the optical device manufacturing method according to the first and second embodiments. FIG. 10(a) illustrates an example of the hollow structure 21 which is configured with a convex spherical surface and a substantially flat surface. The hollow structure 21 illustrated in FIG. 10(a) is further shaped, and thus, as illustrated in FIG. 10(b), a hollow structure 21 which is surrounded by a substantially flat surface, a concave spherical surface, and convex spherical surfaces is formed. Alternatively, as illustrated in FIG. 10(c), a hollow structure 21 surrounded by concavo-convex spherical surfaces can be formed. FIG. 10(d) illustrates an example in which a plurality (two in FIG. 10) of concave spherical surfaces are formed by further processing the right surface of the hollow structure 21 illustrated in FIG. 10(a). The hollow structure 21 and each spherical portion may be formed in a direction different from the direction illustrated in FIG. 10. The shape of the hollow structure 21 is not limited to the shape illustrated in FIG. 10, and other shapes may be adopted depending on the use.

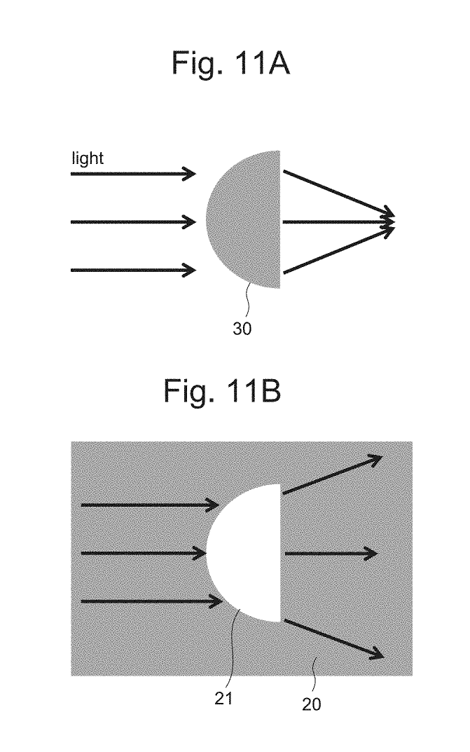

FIG. 11 is a diagram illustrating the optical response of the hollow structure 21 illustrated in FIG. 10(a). FIG. 11(a) illustrates the optical response of a general lens for comparison. A general lens that is formed of a transparent material and has a convex surface and a substantially flat surface functions as a convex lens, and has a function of condensing parallel light (light), for example. On the other hand, the optical device using the hollow structure 21 according to the present invention has a reversed refractive index as compared with a general optical device that is formed of a transparent material 30 and has the same shape. Thus, the optical device according to the present invention has a function different from that of the general optical device. For example, in the example illustrated in FIG. 11, the optical device according to the present invention functions as a so-called concave lens for diffusing parallel light.

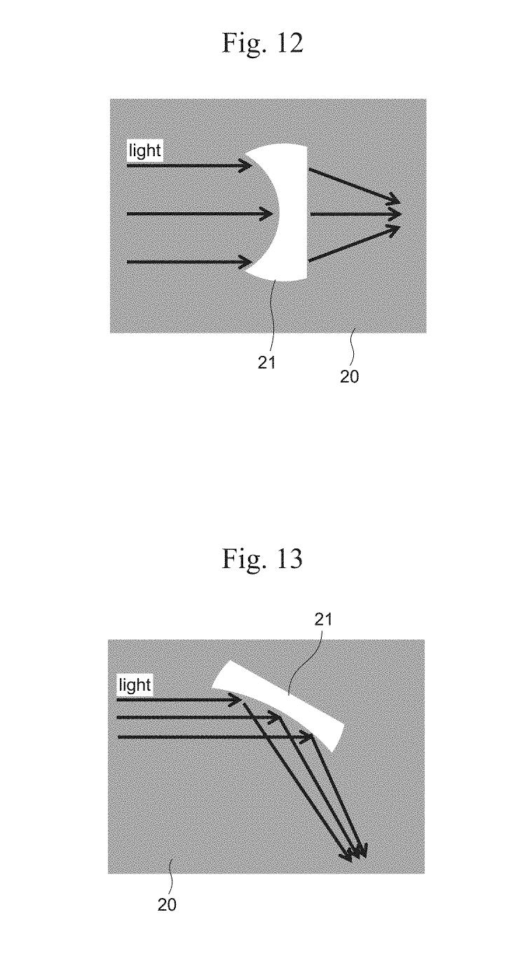

FIG. 12 is a diagram illustrating the optical response of the hollow structure 21 illustrated in FIG. 10(b). As illustrated in FIG. 12, the hollow structure 21 functions as a so-called convex lens for condensing parallel light (light).

The lens using the hollow structure 21 illustrated in FIGS. 11 and 12 exhibits the same optical response regardless of the wavelength of light unless the incident light is dispersed by the transparent board 20. Therefore, it is possible to realize a lens with small chromatic aberration by choosing a material with small dispersion as the board material.

According to the optical device manufacturing method of the present invention, it is also possible to form a reflection type device using total reflection at the interface of the board. As an example, assuming that the transparent board 20 is a quartz glass, the refractive index of the transparent board 20 is approximately 1.46. When the refractive index of the hollow structure 21 is set to 1, the total reflection critical angle is approximately 43°. In a case where an angle of the incident light with respect to the interface exceeds the critical angle all the time, in principle, an optical device with efficiency of 100% can be realized

FIG. 13 illustrates an example in which a concave mirror is formed by the hollow structure 21. In the example illustrated in FIG. 13, a concave surface which is obliquely inclined with respect to the incident parallel light (light) is formed. The concave surface is formed such that the interface has an angle exceeding the critical angle with respect to the incident light all the time, and light is reflected at the interface. Since the interface is a concave surface, the incident parallel light is condensed to a certain point. The device can be used, for example, when coupling incident light to a waveguide which extends in a direction different from the incident direction. When an angle of the interface with respect to incident light decreases below the critical angle, efficiency of the device is reduced. However, in use in which reduction of efficiency is not a problem, the device may be used as a reflection type device. The device can also be used as a device such as a beam splitter by using the fact a part of the incident light is transmitted.

It is possible to form an optical device using an effect other than the effect in that a direction of a light beam is changed by total reflection at the interface. For example, in a case where a Fresnel rhomb-shaped structure is formed by providing a plurality of cavity structures, it is possible to form a broadband wavelength plate similar to the Fresnel rhomb.

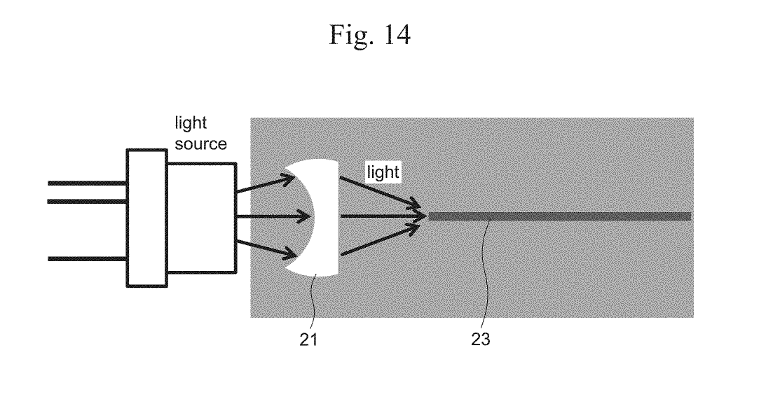

FIG. 14 is a diagram illustrating a configuration example of an optical system using the optical device illustrated in FIG. 10(b). In FIG. 14, when light is coupled from a light source to a waveguide 23, the lens illustrated in FIG. 10(b) is used. For example, in a case where divergent light beams are emitted from the light source, it is necessary to collect the light beams and couple the light beams to the waveguide 23. Assuming that the light source has a plurality of wavelengths, a case where light is coupled to a waveguide 23 capable of propagating the light is considered. In this case, preferably, the chromatic aberration of the lens is as small as possible. When a board material has small dispersion, the chromatic aberration can be suppressed. Thus, the lens formed by the manufacturing method according to the present invention is suitable for such a use.

### Modification Example of Present Invention

The present invention is not limited to the above-described embodiments, and includes various modification examples. The above-described embodiments have been described in detail for a better understanding of the present invention, and are not necessarily limited to those including all the configurations described above. In addition, a part of the configuration of an embodiment can be replaced by the configuration of another embodiment, and the configuration of an embodiment can be added to the configuration of another embodiment. Further, in a part of the configuration of each embodiment, addition of another configuration, omission, substitution can be made.

In the above embodiments, it has been described that an optical function is realized by controlling the shape of a single hollow structure 21. It is desirable that the size of the hollow structure 21 be sufficiently larger (preferably, 10 times or more) than the wavelength of light incident on the optical device.

In the above embodiments, an example in which the hollow structure 21 and the denaturation region 22 are respectively formed on a flat surface orthogonal to the irradiation axis of the laser beam is described. However, the hollow structure 21 and the denaturation region 22 may be formed at positions different from each other in a direction along the irradiation axis. Accordingly, it is possible to adjust the shape of the hollow structure 21 in a direction along the irradiation axis.

### REFERENCE SIGNS LIST

20: transparent board
21: hollow structure
22: denaturation region
100: optical device manufacturing apparatus
101: control device
102: short pulse laser
103: laser beam
104: optical shutter
105: attenuator
106: objective lens
107: automatic stage
108: optical branch device
109: mirror
110: optical shutter
111 attenuator
112: irradiation timing control device
113: spatial pattern control device
114: mirror
115: multiplexer

1. An optical device manufacturing method using a transparent board, comprising:
a first step of producing a hollow structure at the inside of the transparent board by irradiating the transparent board with a first laser beam; and
a second step of changing the shape of the hollow structure by irradiating the vicinity of the hollow structure with a second laser beam and changing the physical properties of the irradiated portion.

2. The optical device manufacturing method according to claim 1,
wherein, in the second step, during at least a part of a period for which irradiation of the first laser beam is performed, irradiation of the second laser beam is simultaneously performed.

3. The optical device manufacturing method according to claim 1,
wherein, in the second step, the shape of the hollow structure at a plurality of positions different from each other is changed, by irradiating, with the second laser beam, a first place in the vicinity of the hollow structure and a second place in the vicinity of the hollow structure that is different from the first place.

4. The optical device manufacturing method according to claim 1,
wherein, in the second step, after the first place is irradiated with the second laser beam, the second place is irradiated with the second laser beam.

5. The optical device manufacturing method according to claim 1,
wherein, in the second step, the first place is irradiated with the second laser beam at the same time as the second place is irradiated with the second laser beam.

6. An optical device comprising:
a transparent board that transmits light; and
a non-spherical hollow structural portion that is formed at the inside of the transparent board by a nonlinear optical effect.

7. The optical device according to claim 6,
wherein the hollow structural portion has an asymmetric shape with respect to the laser irradiation axis as the center, the asymmetric shape causing the nonlinear optical effect.

8. The optical device according to claim 6,
wherein the hollow structural portion has an asymmetric shape with respect to an axis as the center that is orthogonal to the laser irradiation axis, the asymmetric shape causing the nonlinear optical effect.

9. The optical device according to claim 6,
wherein at least a part of the hollow structural portion is a spherical surface, and the other part of the hollow structural portion is an aspherical surface.

10. An optical device comprising:
a transparent board that transmits light; and
a hollow structural portion that is formed at the inside of the transparent board,
wherein the refractive index of the transparent board and the refractive index of the hollow structural portion are different from each other, and
wherein the hollow structural portion includes a first spherical region and a second spherical region having a concave shape which is recessed from the boundary between the hollow structural portion and the transparent board toward the inside of the hollow structural portion.

11. The optical device according to claim 10,
wherein the first spherical region has a convex shape which protrudes from the inside of the hollow structure toward the boundary between the hollow structural portion and the transparent board.

12. The optical device according to claim 10,
wherein a radius of curvature of the first spherical region and a radius of curvature of the second spherical region are different from each other.

13. The optical device according to claim 10,
wherein the second spherical region is a substantially flat surface.

14. The optical device according to claim 10,
wherein the hollow structural portion includes a third spherical region between the first spherical region and the second spherical region.

15. The optical device according to claim 10,
wherein the hollow structural portion is formed as a convex lens or a concave lens.
